(19) United States
(12) Patent Application Publication
(10) Pub. No.: US 2014/0149535 A1
(43) Pub. Date: May 29, 2014

(54) METHOD FOR TRANSMITTING DATA AND MOBILE STORAGE APPARATUS USING THE SAME

(71) Applicants: AUDEN TECHNO CORP., Taoyuan County (TW); CELIO TECHNOLOGY, INC., Taipei City (TW)

(72) Inventors: SZ-WEI FONG, Taipei City (TW); Jei-Fuu Chen, Taipei City (TW); E-Fu Kuo, Taipei City (TW)

(73) Assignees: CELIO TECHNOLOGY, INC., TAIPEI CITY (TW); AUDEN TECHNO CORP., Taoyuan County (TW)

(21) Appl. No.: 13/684,565

(22) Filed: Nov. 25, 2012

(51) Int. Cl. G06F 15/167

(52) U.S. Cl. CPC G06F 15/167
USPC 709/214

(57) ABSTRACT

Disclosure is related to a method for transmitting data, and the method is applicable to a mobile storage apparatus. The mobile storage apparatus provides multiple electronic devices to wirelessly access the files stored in the apparatus. The apparatus determines a scheme to segment the files to be sent according to the files' types, sizes and the order of the connected devices. The files are segmented into multiple sections before the transmission. A power management unit may turn off a communication unit within the apparatus when the transmission procedure enters an idle state. When the jobs in the electronic devices have been completed, the communication unit is again turned on for transmitting next segment until the files are completely transmitted. The invention achieves efficient transmission in a power-saving mode.

### BACKGROUND

1. Technical Field

The present invention is related to a method for transmitting files, and a mobile storage apparatus, in particular, to the mobile storage apparatus capable of transmitting the files in segments in consideration for power saving when multiple devices conduct the accesses.

2. Description of Related Art

A modern smartphone will constantly produce data when it is in use. For example, the smartphone may create photos, share data with others, and continuously downloaded messages. However, the smartphone may not afford sufficient storage to contain the incremental data, even it uses the externally-plugged memory card which is also gradually depleted. Therefore, some technologies have been developed to provide the outside storage for those needs, such as the cloud storage or external mass storage device.

For providing additional storage for the smartphone, there is a provider providing cloud storage service. This service allows a user to select the cloud storage to be the space saving the data while the data is generated. Through this cloud storage service, the data inside may be shared with others over the cloud storage.

For the solution using an external storage device to store the data generated by the smartphone, this external storage device may need to provide wire or wireless communication protocol to communicate with the smartphone or other like electronic devices. Since the external storage is successfully provided, the user is allowed to make a choice if the files are sent to the external storage.

Point-to-point (P2P) communication technology is a preferred way to implement the file exchange between the external storage and the electronic device such as a mobile phone. An access program in the electronic device may be provided for the user to access the external storage. The access program allows the user to take file from or write file into the external storage. In the conventional art, it has been developed that storage provided allowing a plurality of electronic devices simultaneously to make connection over wireless communication protocol, and also access the files in the storage.

### SUMMARY

The mobile storage apparatus is generally equipped with an independent power source. In the case of limited power, a technology is required to meet the demand of allowing one or more electronic devices to access the files smoothly. Therefore, disclosure is related to a method for transmitting files in accordance with the present invention, and the invention is also related to a mobile storage apparatus for implementing the transmission.

According to the embodiment of the invention in the disclosure, the method for transmitting files applied to a storage apparatus includes a beginning step of establishing a connection between the storage apparatus and one or more electronic devices. Next, the storage apparatus may receive a file access command issued from one or more electronic devices. The storage apparatus then retrieves the file to be accessed, and puts the file into a buffer unit of the storage apparatus. The attribute such as the type and size of the file is determined. For example, the file is such as a text document, or the audio/video data which is able to conduct streaming download.

A program installed in the storage apparatus is executed to determine if the file needs to be transmitted in segments according to the file's type and size. The file may be sent in one step at a time if the file is in a small size. For example, the text-based document is as the file to be sent at a time rather than the transmission in segments. If the non-segmented transmission is performed, the storage apparatus activates a communication unit to conduct the transmission.

However, once the file is determined as a bigger file, the file may be required to be sent in segments. The file in the present example is such as a bigger document, audio/video, or the data an electronic device instantly plays. The file is segmented into segments as the storage apparatus acknowledges the file's type and size. These segments are transmitted to connected electronic device sequentially.

While the file is transmitted in segments, a communication unit in the storage apparatus is activated to conduct the transmission. In one exemplary embodiment, the storage apparatus may enter an idle state when one of the segments of the file is completely transmitted. In the meantime, the storage apparatus may selectively turn off the communication unit, or drive the communication unit into a power-saving mode for reducing the power consumption. When one of the segments is completely sent made by one or more electronic devices, again the communication unit is activated for transmitting the next segment. The step of transmission is performed repeatedly until the file(s) is completely transmission.

Accordingly, the electronic device connects to the storage apparatus over a wireless communication protocol. While the connection is established, a program is initiated in the device. Identification information related to the device is transmitted to the storage apparatus for correctly delivering the file by the program.

If the file-to-be-sent is audio or/and video, the electronic device is allowed to perform instant playback. Meanwhile, the file may be segmented into segments as transmitting. In the delivering process, the electronic device plays the segment while receiving this segment. When the playback approaches the end of the played segment, the electronic device may notify the storage apparatus for delivering next segment until the file is transmitted completely.

In one further embodiment, the file's type and size, and the sequence of the electronic devices connected to the storage apparatus are factors for determining the way to perform the transmission. The determination also includes an order to distribute the file.

For example, the file should be transmitted in segments if one or more files are bigger than size of buffer unit. The file should be segmented if multiple devices simultaneously access the same file. The file's segments are delivered to the devices in an order. Also, by the means, the electronic devices are allowed to instantly play the audio/video file.

A mobile storage apparatus in one embodiment includes a data processing unit, a storage unit for storing data, a communication unit, and a power management unit. The power source governed by the power management unit is such as a battery set or an external power supply over a power interface.

### BRIEF DESCRIPTION OF THE DRAWINGS

FIG. 1 describes a schematic diagram of the mobile storage apparatus in accordance with the present invention;

FIG. 2 shows circuit blocks for illustrating the embodiment of the connection between the mobile storage apparatus and an external device;

FIG. 3 shows a schematic diagram illustrating the embodiment of a plurality of electronic devices accessing the claimed mobile storage apparatus;

FIG. 4 shows one more diagram illustrating the embodiment of electronic devices accessing the mobile storage apparatus in accordance with the present invention;

FIG. 5 shows a flow chart illustrating the method for transmitting data applied to the mobile storage apparatus in an embodiment of the present invention;

FIG. 6 shows a flow chart illustrating the method for transmitting data in one further embodiment of the present invention;

FIG. 7 shows a flow chart illustrating the method for transmitting data in one embodiment of the present invention.

### DESCRIPTION OF THE EXEMPLARY EMBODIMENTS

The disclosure is related to a mobile storage apparatus which provides a scheme of an external storage for the kinds of computer systems. The mobile storage apparatus preferably provides function of wireless communication which allows one or more electronic devices to access the digital content over established connections. The mobile storage apparatus includes an independent power supply for its portable design. A battery set is a preferred solution of the power supply. An external device may be an external power source for the storage apparatus, and may simultaneously charge the battery set over a power interface. The power interface is such as a universal serial bus (USB), or any interface capable of receiving the power. The mobile storage apparatus includes an internal storing medium which can be a composite of non-volatile memories. It is noted that the internal storing medium is such as a hard disk, flash memory, or a hybrid storage integrating these two types of memories.

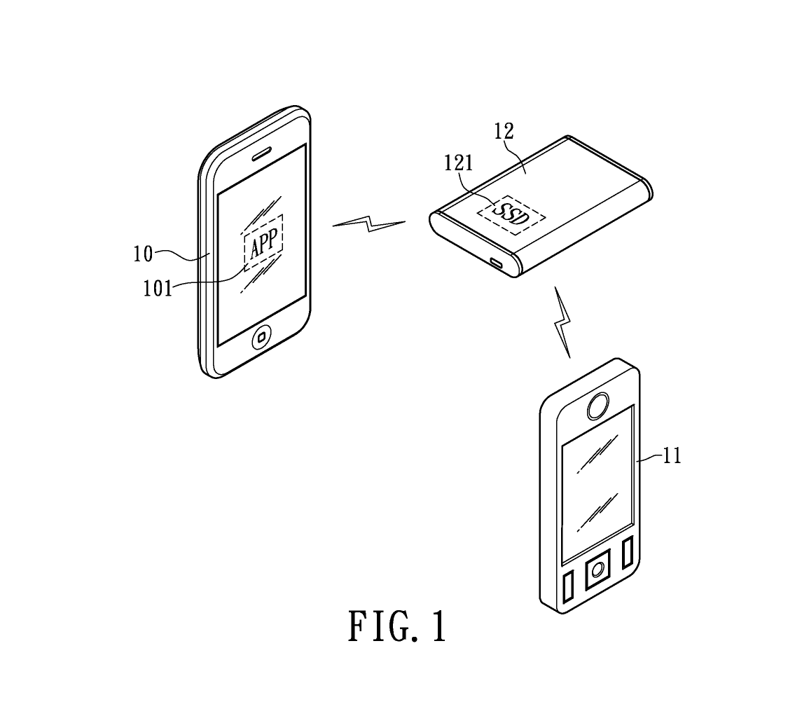

Reference is made to FIG. 1 illustrating a schematic diagram of the mobile storage apparatus in accordance with the present invention.

A mobile storage apparatus 12 is exemplarily shown in the diagram. The apparatus 12 includes a storage unit 121, as described, used for storing digital content. This storage unit 12 is such as hard disk, flash memory, or a hybrid type of integration of the two types of memories. Via the wireless communication technology, the storage apparatus 12 allows multiple electronic devices to access the content simultaneously. The apparatus 12 is not exclusive to connect with an electronic device over a wire for conducting access. The mobile storage apparatus 12 provides the various types of computer devices to access the content. The different electronic devices may share their data with each other through this mobile storage apparatus 12. The storage apparatus 12 is designed to be the extra space for the smart phone or tablet computer, namely the first mobile device 10 and second mobile device 11.

In one of the embodiments, the electronic device connected with the mobile storage apparatus 12 is installed with software program or hardware handling the wireless communication. A software scheme is introduced to generating interface for conveniently accessing the files in the storage apparatus 12. In the diagram, an application program 101 installed in the first mobile device 10 allows a user to launch to access the mobile storage apparatus 12. By this application program 101, an interface is generated to serve browsing the storage unit 121. The interface is a convenient solution allowing the user to operate the accessible content, including retrieving, editing, deleting, and writing into files.

For implementing the technology, exemplarily shown in FIG. 1, allowing one or more electronic devices to access the described mobile storage apparatus, an embedded system is introduced into the mobile storage apparatus. The embedded system renders the processes related to the internal memory, power supply, wire or wireless communication, and file access.

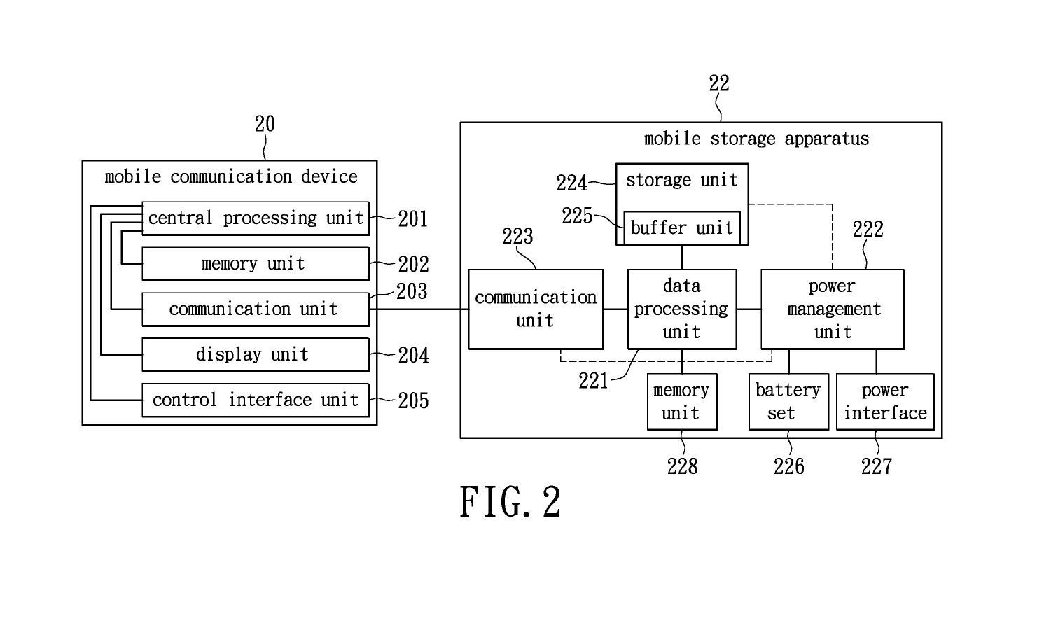

Reference is made to FIG. 2 showing circuit block illustrating the embodiment of the mobile storage apparatus and any connected external device in accordance with the present invention.

A mobile communication device 20, such as a mobile phone, tablet computer, or any computer device, is shown. The mobile communication device 20 is connected to a mobile storage apparatus 22 over a wire or wireless communication technology. One of the objectives of the scheme is to access the data in the mobile storage apparatus 22. The essential components of the mobile communication device 20 are included. A central processing unit 201 is electrically connected with other circuit modules. The central processing unit 201 is used for processing internal signals. The other modules are such as a memory unit 202, a communication unit 203, a display unit 204, and a control interface unit 205.

The memory unit 202 is as an internal storage of the mobile communication device 20. The memory unit 202 is such as an internal memory, or any expandable memory associated to the device 20. Further, the dynamic memory for operating the device 20 is also included.

The communication unit 203 is for the mobile communication device 20 to implement a communication circuit and interface linking to external. The communication unit 203 is preferably a circuit to conduct wireless communication protocol, and is such as WiFi™, Bluetooth™, Near-Field Communication (NFC), or other technology for implementing the file delivery. The communication technology adopted in the present invention is not exclusive to use the wired connection to interconnect the mobile communication device 20 and the mobile storage apparatus 22.

The display unit 204 is provided for the user to browse the files of the mobile storage apparatus 22 through an application program. A visual user interface may be provided for the user to conveniently do file transferring, editing, deleting or the like. To the modern smartphone or tablet computer, the described display unit 204 may be exemplarily cooperated with a touch-controlled module for touch operation.

The mobile communication device 20 may be disposed with a control interface unit 205. The control interface unit 205 is the circuit for processing the input signals in the mobile communication device 20. The input signals may be input from a touch module, a keypad of mobile communication device 20, and not exclusive to voice identification or gesture input. It is noted that the user may generate the input signals via various input devices. Further, any instruction performed to access the mobile storage apparatus 22 is generated from the processes conducted by the control interface unit 205 and the central processing unit 201.

The mobile storage apparatus 22 is exemplarily installed with an embedded system which may be constituted of hardware circuits. In accordance with one of the embodiments, a general-purpose I/O may be incorporated to interconnecting the hardware circuits. Those hardware circuits may be cooperated with software programs. The embodied function modules include a data processing unit 221 for processing the internal data. The data processing unit 221 is electrically connected with the internal circuit modules of apparatus 22. Some other essential components include a power management unit 222 exemplarily having a battery set 226 and a power interface 227, a communication unit 223, a storage unit 224 having a buffer unit 225, and a memory unit 228 in the mobile storage apparatus 222.

The storage unit 224 is exemplarily a storing medium of the mobile storage apparatus 22. The storage unit 224 is preferably a non-volatile memory which is a solid-type memory such as a hard disk or a flash memory. The instructions for accessing the storing unit 224 can be generated while the data processing unit 221 processes the access signals from the mobile communication device 20. The instruction is exemplarily to retrieve the files. Part or whole file may be firstly buffered in the buffer unit 225. The approach of data transmission in the present invention firstly retrieves the data in the buffer unit 225, and then sends them out.

Through the communication unit 223, the mobile storage apparatus 22 is allowed to link one or more electronic devices, for example the described mobile communication device 20. One further embodiment of the present invention may adopt wired communication besides the preferred wireless communication to establish connection to the mobile storage apparatus. The communication unit 223 in the end of the mobile storage apparatus 22 is used to process the signals conducting the wireless communication protocol. On the other hand, the communication unit 203 in the end of the mobile communication device 20 is used to exchange the signals by identical or compatible wireless communication protocols. The protocol adopted between the communication units 203, 223 may be the legacy WiFi™, Bluetooth™, or NFC, and allegedly not exclusive to other data-transmission wireless communication technology.

In order to achieve the requirement of power-saving, the mobile storage apparatus 22 is disposed with the power management unit 222 which is used to manage the electricity use of the apparatus 22. The power management unit 222 is such as a power IC for allocating the power use in the apparatus 22, and including the power supplied to other circuit units. For example, the power management unit 222 is electrically connected with the storage unit 224. When there is no any connection made to the mobile storage apparatus 22, the power management unit 222 forces the apparatus 22 into an idle state, and shutting down the power supplied to the storage unit 224, or alternatively maintain a minimum operating power. Therefore, the scheme achieves the purpose of power saving.

Further, the power management unit 222 is electrically connected with the communication unit 223 for managing the electricity use in the communication unit 223. Operative to the signal conducted from the data processing unit 221, the power management unit 223 controls turning on or off the power supplied to the communication unit 223, or alternatively enables the communication unit 223 into a power-saving mode. For example, the communication unit 223 is turned on to continuously transfer data if in need. On the contrary, the storage apparatus is forced to the idle state if there is no data to be transmitted. In the meantime, the communication unit 223 enters the power-saving mode, including shutting down the power or maintaining a minimum operating power. It is noted that the power source connected to the power management unit 222 is such as a battery set 226 or an external power source over the power interface 227.

The mobile storage apparatus 22 is disposed with the power interface 227, by which the apparatus 22 may take power from the external power source. Besides the external power source supplies power to the mobile storage apparatus 22, the external power source may also charge the battery set 226 through the power management unit 222. Over the power interface 227, the apparatus 22 may take power from external, and the power interface 227 is such as universal serial bus (USB). In addition to the power transferring from the external power source, the power interface 227 is exemplarily in charge of data transmission allowing the mobile storage apparatus 22 to transmit data over wired connection.

More, the mentioned embedded system installed in the mobile storage apparatus 22 as shown in the diagram includes a memory unit 228 which is electrically connected with the data processing unit 221. The memory unit 228 operates as a random-access memory (RAM) for the embedded system. This memory unit 228 is served to dynamically load the program codes from a storage unit 224. The program codes will be executed by the data processing unit 221 to conduct the data transmission. It is noted that, the program codes are pre-stored in the storage unit 224.

After starting up the mobile storage apparatus 22, the operative program codes stored in the storage unit 224 will be loaded into the memory unit 228 and launches the following instructions. In the process, the mobile storage apparatus 22 performs instructions for receiving the file access command(s) from one or more electronic devices; instructions for buffering the file-to-be-transmitted or its segments to the buffer unit 225; instructions for determining the file's type and size; instructions for determining whether or not the file is transmitted in segments according to the file's type and size; instructions for determining an order to transmit the file to the devices based on a sequence that the electronic devices connects to this mobile storage apparatus 22; instructions for orderly transmitting the one or more files to the plurality of electronic devices; instructions for activating the communication unit 223 to transmit the file(s) not in segments; instructions for segmenting the file into segments to conduct the segmented transmission based on the file's type and size; instructions for activating the communication unit 223 to process segmented transmission; instructions for enabling the communication unit 223 into a power-saving mode while the transmission is completed and into an idle state; instructions for activating the communication unit 223 while the one or more electronic devices use up one of the segments; and instructions for repeating the steps of transmitting the data in segments until the data is transmitted completely.

Because the mobile storage apparatus is capable of serving a plurality of electronic devices to access the content at one time, the design of independent power source for the mobile storage apparatus may satisfy minimum power consumption and multiple accesses.

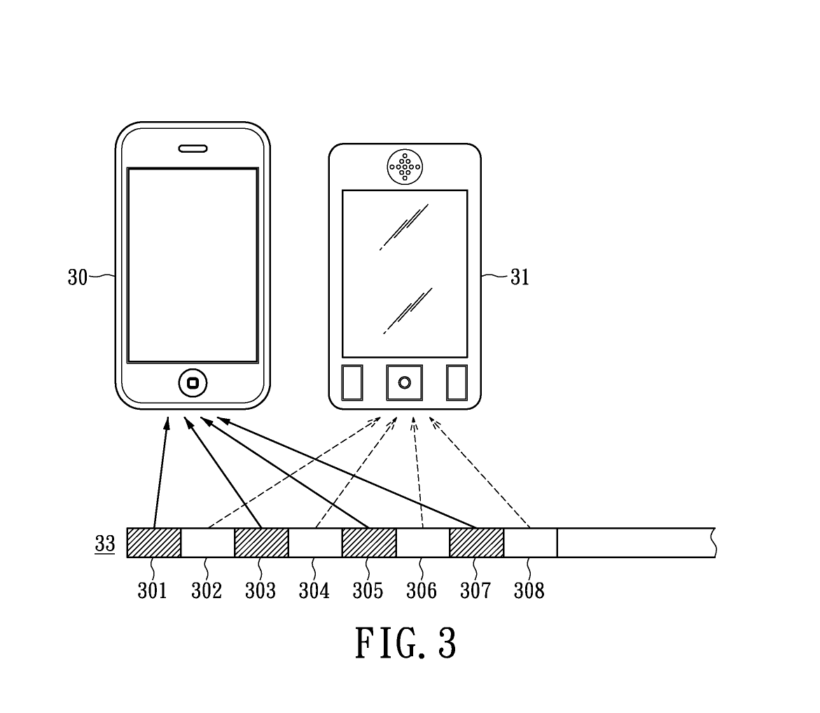

Reference is made to FIG. 3 schematically describing data transmission made as a plurality of electronic devices simultaneously accessing a mobile storage apparatus.

The diagram shows a first electronic device 30 and a second electronic device 31 accessing files in a mobile storage apparatus at a time. In the current example, the first electronic device 30 and the second electronic device 31 respectively access a first file and a second file. The accessed data forms a data stream 33 in the transmission. The data stream 33 exemplarily carries the multiple segments while the first and second files are segmented. The segments are shown as an oblique-line portion denoting the first file segments 301, 303, 305, 307, and a blank portion representing the second file segments 302, 304, 306, 308.

More, the mobile storage apparatus will segment the files in consideration of the smooth transmission while both the first electronic device 30 and the second electronic device 31 simultaneously access different first file and second file respectively. The segments can be orderly transmitted by means of time-sharing transmission, namely to the first electronic device 30 and the second electronic device 31 sequentially.

In one further exemplary example, if the file required by the electronic device is a text document, which is usually a small size file, the file can be transmitted in one process without segments. However, if the size of text document is more than a preset threshold, the file will be segmented into segments for delivered to the different electronic device by the time-sharing scheme. Further, if the file is audio/video, which is generally a big file, the electronic device may be required to instantly playback. In the meantime, the mobile storage apparatus may firstly segment the file based on the requirement of smooth data transmission. The related segments are then transmitted. If one of the segments is completely transmitted, the mobile storage apparatus enters an idle state and also de-activates the communication function while the electronic device plays the segment in the meantime. The communication function may be again activated when the playing process approaches the end of the segment. The next segment will be transmitted. The described scheme achieves purpose of power-saving.

According to one exemplary example, if the different electronic devices simultaneously access the massive audio/video file and the smaller text document at the same time, the audio/video file may be transmitted in segments, and the text document may be transmitted at one time as the devices play the audio/video segment. It is noted that the storage apparatus may enter idle state while the electronic device plays the audio/video segment; however in this case, the storage apparatus may use the idle time to transmit the text document during the time device plays the audio/video segment. When the time for the electronic device playing the audio/video segment approaches completion, a next segment will be transmitted. Thus, the design of the data transmission of the invention satisfies various demands made by the electronic devices. The segments may be made by referring to the files' types and sizes.

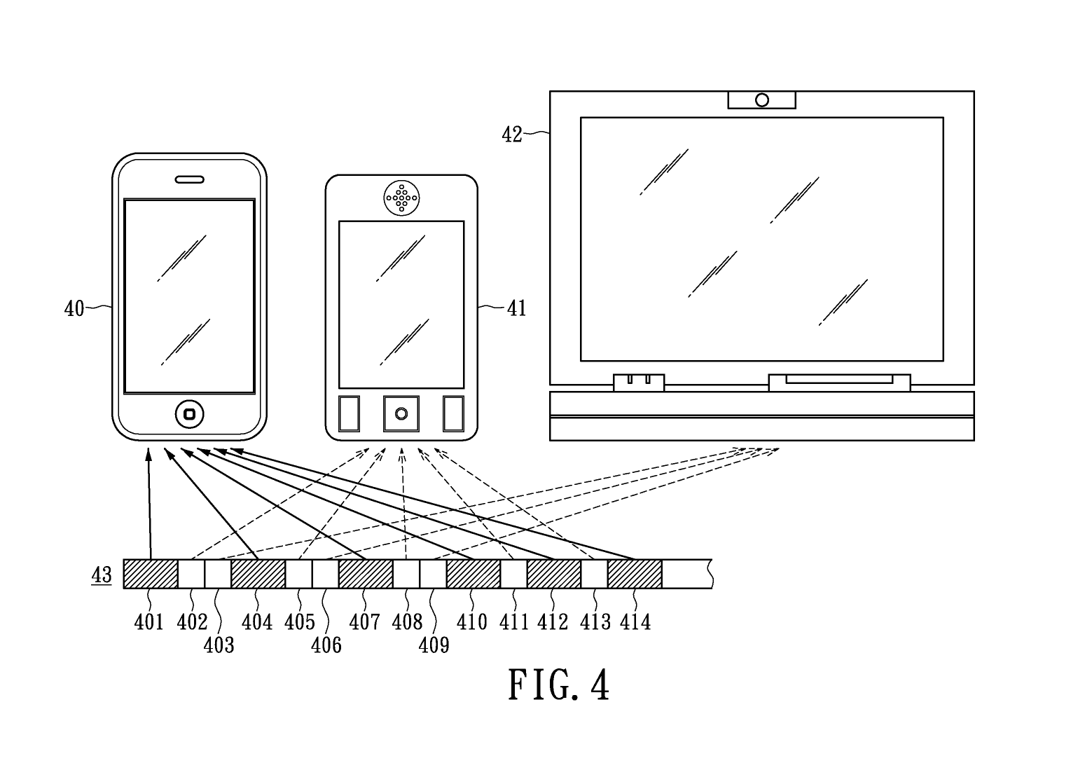

FIG. 4 schematically shows the data transmission performed by the electronic devices as accessing the claimed mobile storage apparatus.

There are three electronic devices shown in this example simultaneously accessing the mobile storage apparatus, also individually issuing the access signals to the storage apparatus. The devices shown in the diagram are represented by a first electronic device 40, a second electronic device 41, and a third electronic device 42.

While the mobile storage apparatus acknowledges the access signals with respect to the different files, the each file's type and size may be identified firstly. The way each electronic device uses the file may also be identified for determining if the files are segmented.

In an exemplary example, when the first electronic device 40 desires to access a video file, the video file is segmented into the segments. As shown in the figure, the file is segmented into the segments represented by the first file segments 401, 404, 407, 410, 412, 414 (the oblique-line portion) in a data stream 43. The size of the segments may be modified according to the actual need. For example, for allowing the first electronic device 40 to smoothly play the video, it should take a buffer size of the mobile storage apparatus or the radio bandwidth into account for performing the segmenting. In the meantime, when the second electronic device 41 accesses another file in the mobile storage apparatus, this file is also segmented into segments such as the second file segments 402, 405, 408, 411, 413 within the data stream 43. Further, when the third electronic device 42 requests to access one further file, the file becomes the third file segments 403, 406, 409 by a segmenting process.

The first file segments 401, 404, 407, 410, 412, 414, the second file segments 402, 405, 408, 411, 413, and the third file segment 403, 406, 409 are arranged within the data stream 43 in sequence. The every segment is formed as the packet for delivery over a wireless communication network. A correlative index is set between the packets for linking each other. A header of the packet is usually used to record the resource and a destination. One of the objectives of the information recorded in the header is to direct the packet to the destination such as the first electronic device 40, the second electronic device 41, or the third electronic device 42.

FIG. 4 shows an exemplary example. The segments of the file are carried in the data stream 43. At the earlier stage of the data transmission, in response to a determined order the first file segment 401 is transmitted to the first electronic device 40, the second file segment 402 is transmitted to the second electronic device 41, and similarly the third file segment 403 is transmitted to the third electronic device 42. In the next stage, the segments 404, 405, 406 are orderly transmitted to the corresponding electronic devices until the data transmitted is completed. The mobile storage apparatus may continuously transmits the mentioned first file segment 410 or 414 when the transmission of the third file segments 403, 406, 409 is completed. In this moment, the mobile storage apparatus will proceed transmitting the first file segments 410, 412, 414 and the second file segments 411, 413 to the first electronic device 40 and the second electronic device 41 respectively.

In the process of creating the data stream 43 carrying the files' segments, the apparatus takes the files' types and sizes into account. If a second file's segments and a third file's segments are inserted in the period of transmitting the first file. The mobile storage apparatus will handle the segmented transmission by a time-sharing method. The time-sharing method serves the plurality of electronic devices able to share the storage space in a mobile storage apparatus, and also the bandwidth for the wireless communication.

In the process of data transmission, the communication unit of the mobile communication device may enter a power-saving mode while the apparatus stay in an idle state. For saving power, the power-saving mode allows the communication unit to be shut down, or maintain a tiny power for the apparatus standby to receive any external signal.

For example, the mobile storage apparatus will conduct segmented transmission when any electronic device plays the audio/video file stored in the mobile storage apparatus. In this process, the electronic device receives the stream by segments, and able to instantly play the file. After the device completely receives one segment, the mobile storage apparatus may firstly shut down the function of communication or maintain a minimum power for the operation. The function of communication will stay shutdown or minimum power consumption until the playback approach an end of the segment. Then the next segment will be transmitted while the function of communication is re-activated.

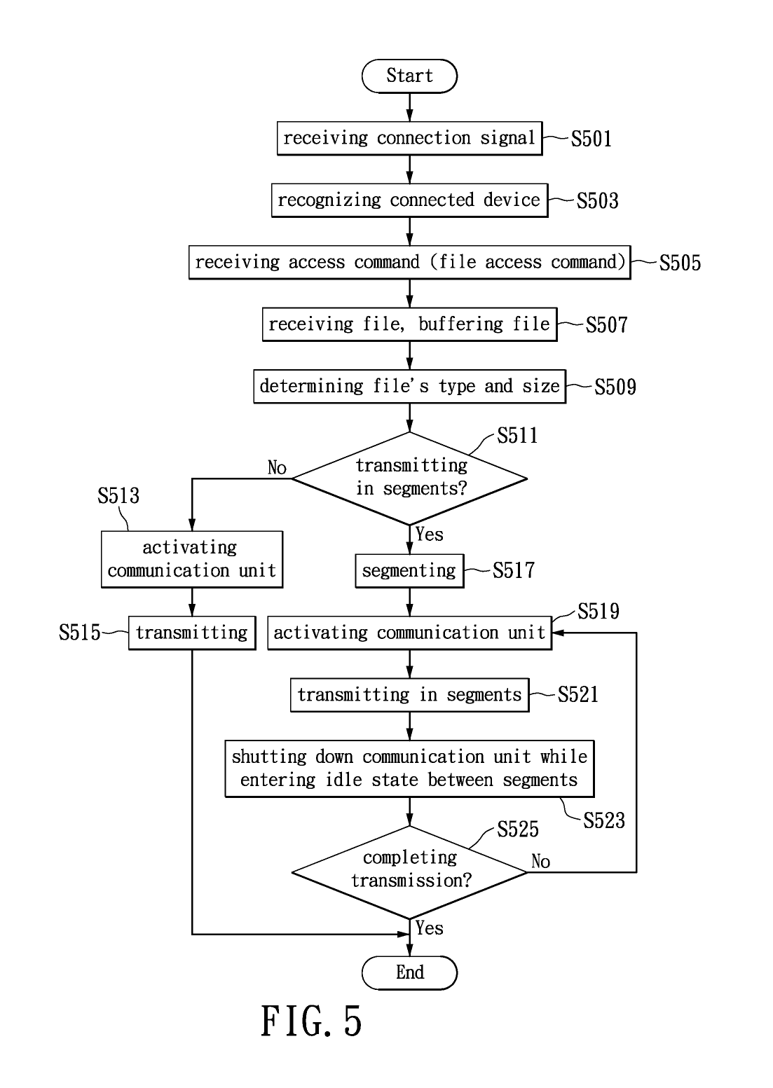

It is featured that the mobile storage apparatus may still able to transmit data under the power-saving mode. The related embodiment is referred to the flow chart illustrated in FIG. 5.

The mobile storage apparatus is exemplarily installed with an embedded system having a processing unit for processing data in the system. A communication unit is included for preparing the communication with one or more electronic devices. The mobile storage apparatus also includes a storing medium for storing the various types of files, and the necessary program codes for operating the system. The storage unit preferably includes an independent power supply which is governed by a power management unit. The power management unit is used to allocate power supplied to the circuit components in the apparatus. The power management unit is able to administer the communication by controlling the power supplied or not to the communication unit.

When the storage apparatus starts up, the instructions for performing data transmission are loaded to the memory unit. The data processing unit takes over the instructions for operating the apparatus. The electronic device is equipped with the circuit for conducting the wireless communication protocol to link with the storage apparatus. A software program corresponding to the operation with the storage apparatus is initiated. The software program is configured to issue connection or access requests to the storage apparatus.

In step S501, the storage apparatus receives a connection request from an electronic device. The storage apparatus retrieves identification information of the electronic device from the request packets as receiving the request. It is noted that the identification information is carried with the signals made by the software program. The identification information is regarded as the destination for the data transmission (step S503). The storage apparatus then receives file access command issued from the connected electronic device, and the command is for receiving one or more files (step S505). The identification information will be correlated with the file(s).

Next, the embedded system of the storage apparatus retrieves the file(s) stored in the storming medium, and extracts the information such as attribute from the file(s). The information may then be buffered into the buffer unit such as the memory shown in FIG. 2 (step S507). The file's type and size can be identified based on the file's attribute (step S509). The type of the file is such as audio, video, text, or their any combination.

The embedded system then determines whether or not the one or more files are segmented for the data transmission according to the one or more files' types and sizes (step S511). If there is no need to process the segmented transmission (“no”), the storage apparatus activates the communication unit (step S513) for delivering the one or more files directly (step S515).

On the contrary, if it is determined the file(s) should be transmitted in segments (“yes”), the embedded system in the apparatus segments the file(s) into segments according to the determined types and sizes of the files (step S517). The communication unit is activated (step S519) to process the segmented transmission (step S521). After the one or segments is completely transmitted and into an idle state, the communication unit enters a power-saving mode such as shutting down the communication unit or maintaining the communication unit to be operated in a minimum power supply (step S523). After that, the step in the method is to determine if the file transmission is completed (step S525). When the transmission is completed (“yes”), the process is terminated. Otherwise, the process goes on if the transmission is not yet finished (“no”) as the communication unit is still on (step S519). The above-described steps for transmitting the segments are repeated unit the whole file is completely transmitted.

It is worth noting that the above determination of if the transmission is operated in segments is based on the size of one or more files compared to the size of buffer unit of storage apparatus. If the size of file(s) is bigger than the space of buffer unit, the file(s) should be sent in segments. For example, the audio/video file is preferably transmitted in segments since it is usually the bigger file occupying bigger space. Further, if the electronic device is configured to instantly play the audio/video file, the relevant transmission should be done in segments rather than delivering the file at one time.

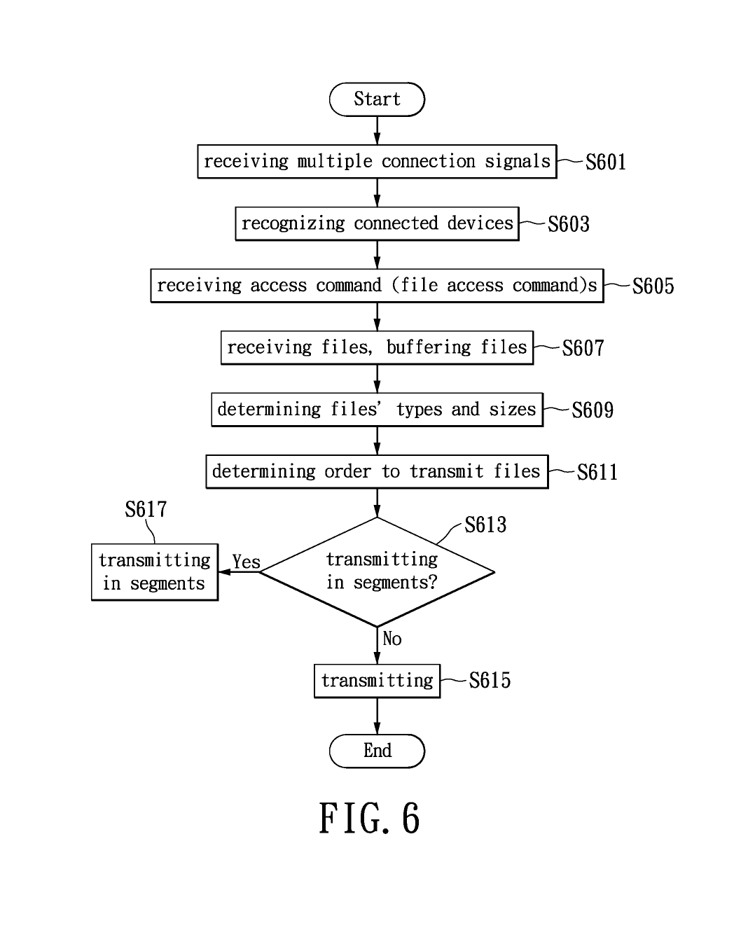

FIG. 6 shows one further embodiment illustrating multiple electronic devices simultaneously accessing and connected with the storage apparatus. In the moment, the file is distributed in segments, such as the examples described in FIGS. 3 and 4. The segmented transmission is able to serve the plurality of electronic devices to take the file(s). The segmented transmission is also for the electronic devices to conduct instant playback.

When the electronic device instantly plays the accessed audio/video file, the embedded system segment-by-segment distributes the file. The system may enter an idle state as the electronic device playing the segment transmitted from the storage apparatus. The idle system is with the temporary shutdown of the communication unit, or a minimum power supplied to the communication unit for acknowledging any signal from the electronic devices. When the communication unit is temporarily shut down, the system may estimate the time to re-activate the communication unit. The embedded system re-activates the communication unit for transmitting a next segment when the system acknowledges that the electronic device uses up the one of the segments or approaches the end. The embedded system may temporarily shut down the communication unit or make it in a state of minimum power consumption when the electronic device is playing the audio/video file. The electronic device may issue a signal to notify the storage apparatus to activate the communication unit when it almost finishes playing the segment of audio/video file. The system repeats the steps of data transmission until the audio/video is completely played, or the electronic device stops the playback.

The embodiment described in the flow chart shown in FIG. 6 is applicable to the operation as the plurality of electronic devices accessing the storage apparatus.

In the beginning, such as step S601, the storage apparatus receives a plurality of connection signals. Refer to the descriptions in FIGS. 3 and 4, the storage apparatus is capable of receiving multiple connection requests at one time. A specific wireless communication protocol is introduced to establishing the connections for the electronic devices to link the storage apparatus. In step S603, the storage apparatus may extract identification information of the every electronic device from the connection requests. Therefore the each electronic device can be identified. The related information may include the storage apparatus' destination address for correctly responding signals.

It is worth noting that a specific program installed in the electronic device is initiated to establish connection with the storage apparatus. This program serves the electronic device to issue various requests to the storage apparatus. The request may carry each device's identification information including the destination and source. The requests may further include connection request, browsing files, retrieving files, and editing. Any notification relating the current state of the electronic device sent to the storage apparatus may be provided by this program. The program may also conduct audio/video playback or text reading.

After the connection between the storage apparatus and the every electronic device is established, such as step S605, the apparatus may receive the file access commands specified to the files from the different devices. After that, the storage apparatus will retrieve the files in response to those file access commands. In step S607, the files will be firstly buffered in the memory such as a buffer unit of the storage apparatus. The software program installed in the storage apparatus is allowed to identify the every file's attribute such as type and size (step S609). The file's type is such as video, audio, text, or in combination thereof The storage apparatus adaptively performs segmenting process according to the determined type and size. Since the storage apparatus may receive file access commands from multiple electronic devices, the order of making the connections and the attribute of the files-to-be-transmitted may all be the factors to conduct the segmented transmission. The software program in the storage apparatus then determines an order to transmit the file(s) (step S611).

Next, in step S613, the storage apparatus determines that if the file(s) is transmitted in segments. It is noted that, the status under the electronic device accessing the storage apparatus may dominate the strategy of segmented transmission during the period of data transmission. For example, if one of the files is completed transmitted, the storage apparatus may still determine the attributes associated with the remaining files not yet to be completely transmitted. In which, the size of the remaining files, the number of the connected electronic devices and the order to establish connections thereto may be taken in to consideration for configuring the way to conduct the transmission.

It is determined that the file needs not to be segmented for the delivery. The file may not be too big to send at a time. Also, if other files are completely transmitted, the present file may need not to be segmented. That is, such as step S615, the file is directly transmitted under the above-mentioned circumstances. In the moment, the storage apparatus activates the communication unit for orderly transmitting the one or more files to the electronic devices. On the contrary, such as step S617, if it is determined that the storage apparatus transmits the file(s) in segments; the segments are delivered to the electronic devices in an order.

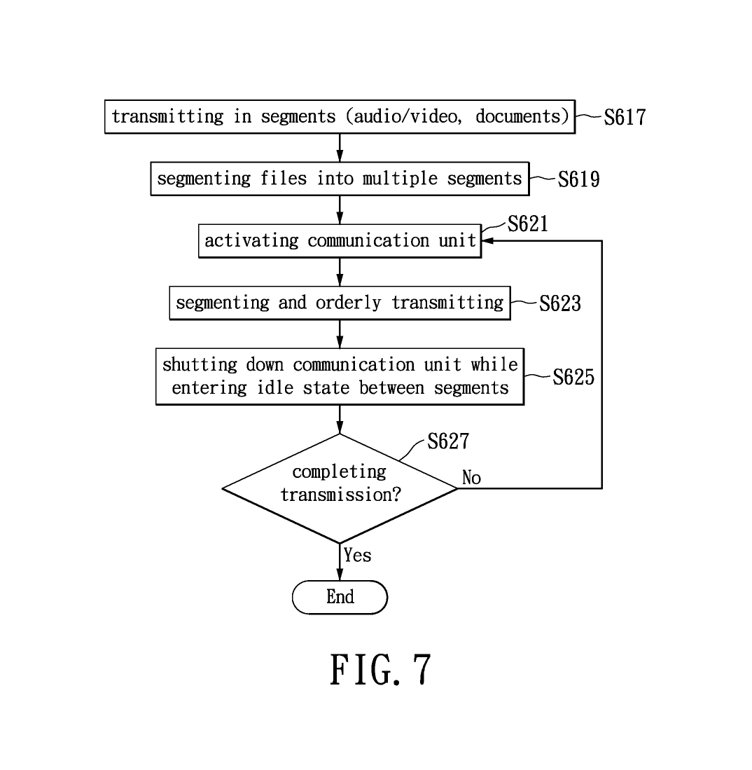

The steps following up the step S617 are referred to FIG. 7.

In step S617, the storage apparatus processes segmented transmission according to the file's attribute. The file may be categorized into audio, video, text or their combination. In step S619, the file, based on the file's type, is segmented into a plurality of segments. The next step, such as step S621, the communication unit is activated to conduct the segmented transmission. The segments may be orderly transmitted to the electronic devices issuing the file access commands (step S623). The communication unit may then be forced into power-saving mode or be de-activated when one of the segments is completely transmitted and as well the storage apparatus entering the idle state (step S625).

During the transmission, if the transmission is suspended or the file (or segment) is buffered in the buffering memory for serving the electronic device smoothly plays the file, the storage apparatus may be into an idle state while finishing transmitting the current one segment. In this idle state, the radio may be shutdown. When the process electronic device plays the segment approaches the end, the storage apparatus will acknowledge that since the device issues a signal indicative of using up the segment. The storage apparatus acknowledges that the next segment should be transmitted. The storage apparatus against activates the communication unit to process the next segmented transmission.

The steps of segmented transmission will be repeated until the transmission is completed. During the transmission, the storage apparatus, in step S627, constantly checks if the transmission is completed. If the transmission is still proceeding, the process goes to step S621 for continuously transmitting while the communication unit is on. Otherwise, the process will be ended when the storage apparatus acknowledges that all the connected electronic devices finish their transmissions.

If the size of the file-to-be-accessed is bigger than the size of the buffer are of the storage apparatus, the file is segmented into segments as delivering. A time-sharing transmission technology may be a preferred way to conduct the data transmission. Further, if the different electronic devices access the same file, the file may be segmented into segments and copies for the delivery under time-sharing scheme. Still further, if any electronic device needs to instantly play the audio/video file, the storage apparatus may selectively transfer the file in segments. The segmented transmission is to guarantee a smooth data transmission, since it takes the transmitting bandwidth, buffer size and time for playback into account.

To sum up, the invention provides a solution of allowing multiple devices to access a mobile storage apparatus simultaneously. A wireless communication is introduced to performing the access. For smoothly transferring data and saving energy, the solution is to conduct file transferring in segments and force the communication unit into power-saving mode as in idle state. The invention optimizes data transmission especially over a wireless communication.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method for transmitting a file, comprising:
a storage device receiving one or more file access commands issued from one or more electronic devices;
receiving the one or more files and buffering into a buffer unit of the storage device;
in response to attributes of the one or more files, determining if the one or more files are transmitted in segments;
if it is determined that the one or more files are not transmitted in segments, the storage device activating a communication unit for performing the transmission;
if it is determined that the transmission is performed in segments, the storage device segmenting the one or more files into multiple segments in response to the attributes;
activating the communication unit for performing the transmission in segments; when one of the segments is completely transmitted and into an idle state, the communication unit is configured to enter a power-saving mode; when one or more electronic devices almost uses up the received segment, the communication is again activated for transmitting a next segment; and
repeating the steps of transmitting the segments until the transmission of one or more files is completed.

2. The method of claim 1, wherein the step of determining whether or not the file is transmitted in segments further includes:
it enables segmented transmission if the size of one or more files is bigger than size of the buffer unit;
it enables segmented transmission if multiple electronic devices simultaneously access the same one or more files in the storage apparatus; and
it enables segmented transmission if electronic device instantly plays the audio/video file.

3. A method for transmitting data, comprising:
a storage apparatus receiving file access commands from a plurality of electronic devices;
in response to the file access commands, retrieving one or more files, and buffering the one or more files into a buffer unit of the storage apparatus;
according to attribute of the one or more files and an order of the electronic devices accessing the storage apparatus, determining whether or not the one or more files is transmitted in segments, and also order to transmit the one or more files.
if it is determined not to perform segmented transmission, the storage apparatus activating a communication unit for transmitting the one or more files to the electronic devices in response of the determined order;
if it is determined to perform segmented transmission, the storage apparatus segments the one or more files into segments according to attribute of each file;
activating the communication unit for transmitting one or more files in segments, transmitting each segment to the electronic devices in order;
when one segment is completely transmitted to the one electronic device and the electronic device entering an idle state, enabling the communication unit to a power-saving mode; when the electronic device uses up the received segment, enabling the communication unit to transmit next segment; and
repeating the steps of transmitting segment until the one or more files are completely transmitted.

4. The method of claim 3, wherein the step of determining if performing the segmented transmission further includes:
it enables segmented transmission if the size of one or more files is bigger than size of the buffer unit;
it enables segmented transmission if multiple electronic devices simultaneously access the same one or more files in the storage apparatus; and
it enables segmented transmission if electronic device instantly plays the audio/video file.

5. The method of claim 4, wherein, a time-sharing transmission is performed to transmit the one or more files if the electronic devices simultaneously access the same one or more files.

6. A mobile storage apparatus, comprising:
a data processing unit for processing internal data of the mobile storage apparatus;
a storage unit, electrically connected to the data processing unit, having a buffer unit for buffering the file-to-be-transmitted or the file's segments;
a communication unit, electrically connected to the data processing unit, serving one or more electronic devices to establish connection with the mobile storage apparatus;
a power management unit, electrically connected to the data processing unit, the storage unit, and the communication unit, for managing power supplied to the mobile storage apparatus, the inside storage unit, and the communication unit, and a power source connected to the power management unit includes a battery set or an external power source connected over a power interface;
a memory unit, electrically connected to the data processing unit, loading program codes for performing file transmission executed by the data processing unit as starting up the mobile storage apparatus, the program codes including:
instructions for receiving file access command issued from the one or more electronic devices;
instructions for buffering the file-to-be-transmitted or the file's segments to the buffer unit;
instructions for determining the file's attribute;
instructions for determining whether or not performing segmented transmission according to the file's attribute;
instructions for determining an order to transmit the file in response to a sequence of the electronic devices connected with the mobile storage apparatus;
instructions for orderly transmitting the one or more files to the electronic devices;
instructions for activating the communication unit for transmitting the file not in segments;
instructions for segmenting the file into segments according to the file's attribute;
instructions for activating the communication unit for transmitting the file in segments;
instructions for enabling the communication unit into a power-saving mode while the segmented transmission is completed and in an idle state;
instructions for activating the communication unit while the one or more electronic devices use up one of the segments;
instructions for repeating the steps of segmented transmission until the file is completely transmitted.
